(19) United States
(12) Patent Application Publication
(10) Pub. No.: US 2022/0347708 A1
(43) Pub. Date: Nov. 3, 2022

(54) WATER SPRINKLER HEAD PROTECTIVE DEVICE AND METHODS

(71) Applicant: Paul Kim, Diamond Bar, CA (US)

(72) Inventor: Paul Kim, Diamond Bar, CA (US)

(21) Appl. No.: 17/246,164

(22) Filed: Apr. 30, 2021

(51) Int. Cl. B05B 15/16

(52) U.S. Cl. CPC B05B 15/16

(57) ABSTRACT

The present invention discloses a protective device for a head of water sprinkler and methods of making and using the same.

### FIELD OF THE INVENTION

The present invention generally relates a water sprinkler head protective device and methods of making and using the same.

### BACKGROUND OF THE INVENTION

In-ground sprinkler heads are common for both residential and commercial landscapes. Lawn irrigating system generally comprised of a plurality of water sprinklers.

Many times passersby, either on foot or with some form of vehicle/landscaping equipment, knowingly or unknowingly hit the sprinkler head. This usually results in a broken sprinkler head, which is a headache to replace. Moreover, if the broken sprinkler head is not found in time, the uncontrolled leaking water, or lack thereof, could cause damage to the surrounding area.

Techniques and devices to protect water sprinkler heads are developed to address various issues with water sprinkler systems with limited success. For example, U.S. Pat. No. 7,717,360B1 discloses a device to protect water sprinkler heads from dirt and overgrown grass. No devices have been developed to protect water sprinkler heads from impacts by a machinery or a footstep.

Therefore, there is a need for water sprinkler head protection system and device and methods of making and using the same.

The embodiments below address the above described issues, needs, and/or objects.

### SUMMARY OF THE INVENTION

In one aspect of the present invention, it is provided a protective device for a water sprinkler head, the protective device comprising a body structure configured to enclose a water sprinkler head, the body structure comprising:

a top with an opening to allow the water sprinkler head to rise up to distribute water to irrigate a plant or grass of a landscape, and

a protective support structure having an engaging element configured to allow the protective device to engage with a site of ground or grass,

wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

In some embodiments of the invention protective device, optionally in combination of any or all the various embodiments disclosed herein, the top and the protective structure are permanently joined or detachably joined.

In some embodiments of the invention protective device, optionally in combination of any or all the various embodiments disclosed herein, the engaging element comprises two or more stakes configured to provide a hold on the ground or grass or to be driven to the ground.

In some embodiments of the invention protective device, optionally in combination of any or all the various embodiments disclosed herein, the protective device has a larger side and a smaller side of a funnel shape, the larger side being the top side.

In some embodiments of the invention protective device, optionally in combination of any or all the various embodiments disclosed herein, the protective device has a larger side and a smaller side of a funnel shape, the smaller side being the top side.

In some embodiments of the invention protective device, optionally in combination of any or all the various embodiments disclosed herein, the water sprinkler head is a long neck water sprinkler head, and the protective support structure includes a clip to engage the two or more stakes.

In some embodiments of the invention protective device, optionally in combination of any or all the various embodiments disclosed herein, the protective device is formed from a material comprising one or more of a plastics, a ceramic material, concrete, a glass composition, a metallic material, a wooden material, or any combinations thereof.

In some embodiments of the invention protective device, optionally in combination of any or all the various embodiments disclosed herein, the metallic material is a metallic sheet, metallic rod, or metallic wire.

In another aspect of the present invention, it is provided a method of fabricating a protective device for a water sprinkler head, the method comprising providing a design of the protective device, and fabricating the protective device according to the design, wherein

the protective device comprises a body structure configured to enclose a water sprinkler head, the body structure comprising:

a top with an opening to allow the water sprinkler head to rise up to distribute water to irrigate a plant or grass of a landscape, and

a protective support structure having an engaging element configured to allow the protective device to engage with a site of ground or grass,

wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

In some embodiments of the invention method, optionally in combination of any or all the various embodiments disclosed herein, the top and the protective structure are permanently joined or detachably joined.

In some embodiments of the invention method, optionally in combination of any or all the various embodiments disclosed herein, the engaging element comprises two or more stakes configured to provide a hold on the ground or grass or to be driven to the ground.

In some embodiments of the invention method, optionally in combination of any or all the various embodiments disclosed herein, the protective device has a larger side and a smaller side of a funnel shape, the larger side being the top side.

In some embodiments of the invention method, optionally in combination of any or all the various embodiments disclosed herein, the protective device has a larger side and a smaller side of a funnel shape, the smaller side being the top side.

In some embodiments of the invention method, optionally in combination of any or all the various embodiments disclosed herein, the water sprinkler head is a long neck water sprinkler head, and the protective support structure includes a clip to engage the two or more stakes.

In some embodiments of the invention method, optionally in combination of any or all the various embodiments disclosed herein, the protective device is formed from a material comprising one or more of a plastics, a ceramic material, concrete, a glass composition, a metallic material, a wooden material, or any combinations thereof.

In some embodiments of the invention method, optionally in combination of any or all the various embodiments disclosed herein, the metallic material is a metallic sheet, metallic rod, or metallic wire.

### BRIEF DESCRIPTION OF THE DRAWINGS

FIGS. 1A-1D illustrate embodiments of the invention water sprinkler head protection device.

FIG. 2 illustrate an embodiment of the invention water sprinkler head protection device for a long neck water sprinkler head.

### DETAILED DESCRIPTION OF THE INVENTION

### Definitions

As used herein, the term “pre-attached” means the sprinkler head is fabricated with the protective device before installation.

As used herein, the term “detachable” means the protective device can be attached to any existing/installed sprinkler system.

### Protective Device

In one aspect of the present invention, it is provided a protective device for a water sprinkler head, the protective device comprising a body structure configured to enclose a water sprinkler head, the body structure comprising:

a top with an opening to allow the water sprinkler head to rise up to distribute water to irrigate a plant or grass of a landscape, and

a protective support structure having an engaging element configured to allow the protective device to engage with a site of ground or grass,

wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

In some embodiments of the invention protective device, optionally in combination of any or all the various embodiments disclosed herein, the top and the protective structure are permanently joined or detachably joined.

In some embodiments of the invention protective device, optionally in combination of any or all the various embodiments disclosed herein, the engaging element comprises two or more stakes configured to provide a hold on the ground or grass or to be driven to the ground.

In some embodiments of the invention protective device, optionally in combination of any or all the various embodiments disclosed herein, the protective device has a larger side and a smaller side of a funnel shape, the larger side being the top side.

In some embodiments of the invention protective device, optionally in combination of any or all the various embodiments disclosed herein, the protective device has a larger side and a smaller side of a funnel shape, the smaller side being the top side.

In some embodiments of the invention protective device, optionally in combination of any or all the various embodiments disclosed herein, the water sprinkler head is a long neck water sprinkler head, and the protective support structure includes a clip to engage the two or more stakes.

In some embodiments of the invention protective device, optionally in combination of any or all the various embodiments disclosed herein, the protective device is formed from a material comprising one or more of a plastics, a ceramic material, concrete, a glass composition, a metallic material, a wooden material, or any combinations thereof.

In some embodiments of the invention protective device, optionally in combination of any or all the various embodiments disclosed herein, the metallic material is a metallic sheet, metallic rod, or metallic wire.

The protective device can be any shape (round, square, etc.), and suitable for use with any shaped sprinkler head.

### Methods of Fabrication

In another aspect of the present invention, it is provided a method of fabricating a protective device for a water sprinkler head, the method comprising providing a design of the protective device, and fabricating the protective device according to the design, wherein

the protective device comprises a body structure configured to enclose a water sprinkler head, the body structure comprising:

a top with an opening to allow the water sprinkler head to rise up to distribute water to irrigate a plant or grass of a landscape, and

a protective support structure having an engaging element configured to allow the protective device to engage with a site of ground or grass,

wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

In some embodiments of the invention method, optionally in combination of any or all the various embodiments disclosed herein, the top and the protective structure are permanently joined or detachably joined.

In some embodiments of the invention method, optionally in combination of any or all the various embodiments disclosed herein, the engaging element comprises two or more stakes configured to provide a hold on the ground or grass or to be driven to the ground.

In some embodiments of the invention method, optionally in combination of any or all the various embodiments disclosed herein, the protective device has a larger side and a smaller side of a funnel shape, the larger side being the top side.

In some embodiments of the invention method, optionally in combination of any or all the various embodiments disclosed herein, the protective device has a larger side and a smaller side of a funnel shape, the smaller side being the top side.

In some embodiments of the invention method, optionally in combination of any or all the various embodiments disclosed herein, the water sprinkler head is a long neck water sprinkler head, and the protective support structure includes a clip to engage the two or more stakes.

In some embodiments of the invention method, optionally in combination of any or all the various embodiments disclosed herein, the protective device is formed from a material comprising one or more of a plastics, a ceramic material, concrete, a glass composition, a metallic material, a wooden material, or any combinations thereof.

In some embodiments of the invention method, optionally in combination of any or all the various embodiments disclosed herein, the metallic material is a metallic sheet, metallic rod, or metallic wire.

The protective device can be made from any material, including various types of plastics, a ceramic material, concrete, a glass composition, a metallic material, a wooden material, or any combinations thereof. It can also be manufactured using injection molding, 3D printing, or any type of other manufacturing process.

### Method of Use

The protective device for water sprinkler head can be used for the protection of head of any water sprinkler systems. Such water sprinklers can be landscape irrigation, agriculture irrigation, or garden plant irrigation or golf course grass irrigation.

### EXAMPLES

The examples described below illustrate, and shall not be construed to limit, the scope of the disclosed invention.

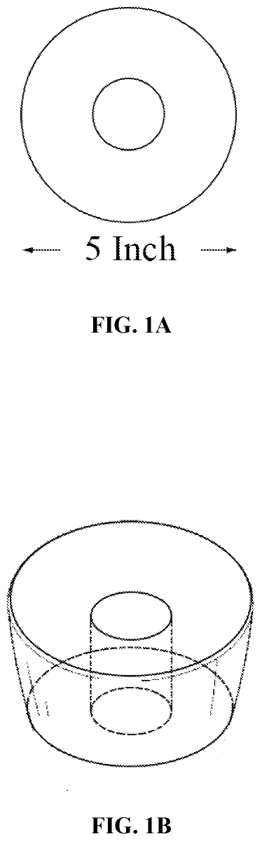

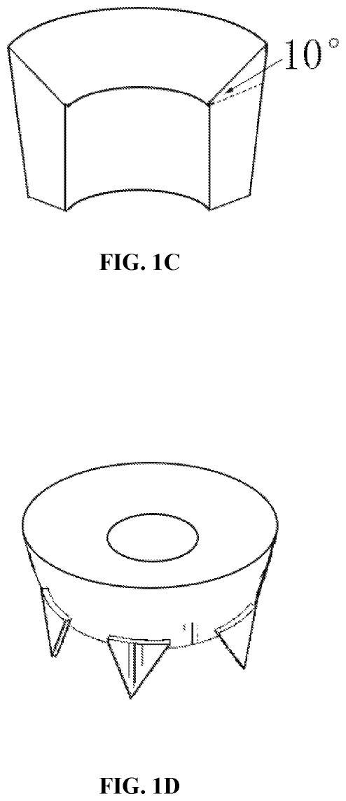

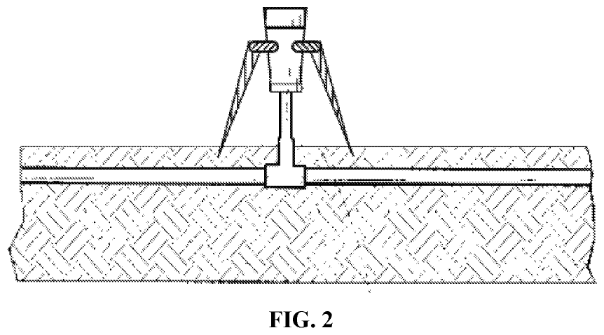

FIGS. 1-2 show various water sprinkler head device of invention that were made and tested.

Referring to FIG. 1A, a water sprinkler head protective device 1 having top side 2. The top 2 has an opening 4 to receive a head of a water sprinkler (data not shown). In FIG. 1B, a water sprinkler head protective device 1 is shown to have a top side 2 with an opening 4 on the top side 2 and a funnel shape supporting structure 3, which can be a side wall (FIG. 1B here) or another structure (see FIG. 1D below). In FIG. 1B, the funnel shape device 1 has a larger side, which is the top side 2.

Referring to FIG. 1C, a funnel shape water sprinkler head protective device 1 is shown in its side view to have a funnel shape with a degree of inclination, e.g., 10 degrees. The bottom side 2′ is smaller and has an opening 4′, which corresponds to the opening 4 on the top side 2 of FIGS. 1A and 1B.

Referring to FIG. 1D, a water sprinkler head protective device 1 is shown to have a top side 2 with an opening 4 and a support structure 3 having three legs 5. The legs 5 are configured to provide engagement to a side of grass or ground.

Referring to FIG. 2, a protective device 1 for a long neck water sprinkler head is shown. The protective device 1 is shown to have a top side 2 (now shown) with an opening 4 (not shown) to receive a head of long neck water sprinkler, a protective support structure 3 having long legs 5, the protective support structure being configured to clip with the stake of the longneck sprinkler via a clip 6. The sprinkler stake will prevent the sprinkler from moving 180 degrees and being broken during trimming of grass.

Those skilled in the art will know, or be able to ascertain, using no more than routine experimentation, many equivalents to the specific embodiments of the invention described herein. These and all other equivalents are intended to be encompassed by the following claims.

I claim:

1. A protective device for a water sprinkler head, comprising a body structure configured to enclose a water sprinkler head, the body structure comprising:
a top with an opening to allow the water sprinkler head to rise up to distribute water to irrigate a plant or grass of a landscape, and
a protective support structure having an engaging element configured to allow the protective device to engage with a site of ground or grass,
wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

2. The protective device according to claim 1, wherein the top and the protective structure are permanently joined or detachably joined.

3. The protective device according to claim 1, wherein the engaging element comprises two or more stakes configured to provide a hold on the ground or grass or to be driven to the ground.

4. The protective device according to claim 1, having a larger side and a smaller side of a funnel shape, the larger side being the top side.

5. The protective device according to claim 1, having a larger side and a smaller side of a funnel shape, the smaller side being the top side.

6. The protective device according to claim 3, wherein the water sprinkler head is a long neck water sprinkler head, and the protective support structure includes a clip to engage the two or more stakes.

7. The protective device according to claim 1, which is formed from a material comprising one or more of a plastics, a ceramic material, concrete, a glass composition, a metallic material, a wooden material, or any combinations thereof.

8. The protective device according to claim 7, wherein the metallic material is a metallic sheet, metallic rod, or metallic wire.

9. A method of fabricating a protective device for a water sprinkler head, comprising providing a design of the protective device, and fabricating the protective device according to the design, wherein
the protective device comprises a body structure configured to enclose a water sprinkler head, the body structure comprising:
a top with an opening to allow the water sprinkler head to rise up to distribute water to irrigate a plant or grass of a landscape, and
a protective support structure having an engaging element configured to allow the protective device to engage with a site of ground or grass,
wherein the protective device is optionally pre-attached to the water sprinkler head or attachable/detachable to the water sprinkler head in that the protective device is configured to releasably engage the water sprinkler head when it rises up from the ground to irrigate the plant or grass and release the water sprinkler head to allow it to retreat to the ground when it completes irrigating the plant or grass.

10. The method according to claim 9, wherein the top and the protective structure are permanently joined or detachably joined.

11. The method according to claim 9, wherein the engaging element comprises two or more stakes configured to provide a hold on the ground or grass or to be driven to the ground.

12. The method according to claim 9, having a larger side and a smaller side of a funnel shape, the larger side being the top side.

13. The method according to claim 9, having a larger side and a smaller side of a funnel shape, the smaller side being the top side.

14. The method according to claim 9, wherein the water sprinkler head is a long neck water sprinkler head, and the protective support structure includes a clip to engage the two or more stakes.

15. The method according to claim 9, wherein which is formed from a material comprising one or more of a plastics, a ceramic material, concrete, a glass composition, a metallic material, a wooden material, or any combinations thereof.

16. The method according to claim 9, wherein the metallic material is a metallic sheet, metallic rod, or metallic wire.
